(19) United States
(12) Patent Application Publication
(10) Pub. No.: US 2011/0058263 A1
(43) Pub. Date: Mar. 10, 2011

(54) MICRO PRIME LENS SYSTEM

(75) Inventors: Chun-Hong Chen, Taichung (TW); Jian-Wei Lee, Taichung (TW)

(73) Assignee: ASIA OPTICAL CO., INC., Taichung (TW)

(21) Appl. No.: 12/629,972

(22) Filed: Dec. 3, 2009

(30) Foreign Application Priority Data
Sep. 9, 2009 (TW) 98130378

(51) Int. Cl. G02B 13/04

(52) U.S. Cl. 359/753

(57) ABSTRACT

A micro prime lens system is provided. From an object side to an image side, the micro prime lens system sequentially includes a first lens, a second lens, a third lens and a fourth lens, which have a positive, a negative, a positive and a negative index of refraction, respectively. The third lens is an aspherical lens made of glass material and conforms to the following condition: 0.3<f₃/f<1.5, wherein f₃ represents a focal length of the third lens, and f represents a focal length of the micro prime lens system. The utilization of glass aspherical surfaces of the third lens effectively improves the aberration of the micro prime lens and successfully decreases the F number, and in other words to increase aperture diameter. Therefore, the luminous flux density is increased and the image resolution is raised.

This Application claims priority of Taiwan Patent Application No. 098130378, filed on Sep. 9, 2009, the entirety of which is incorporated by reference herein.

### BACKGROUND OF THE INVENTION

1. Field of the Invention

The invention relates to an optical device, and in particular, to a micro prime lens system.

2. Description of the Related Art

In portable electronic products, such as mobile phones, portable computers, personal digital assistants and so on, most have built-in micro prime lens systems which have the ability to capture images and record video. However, with continued miniaturization of portable electronic products, the micro prime lens systems therein are also being required to decrease in size, resulting in decreased aperture diameter. Specifically, by further miniaturizing the aperture diameter of lenses in the micro prime lens system, luminous flux density decreases. Therefore, a micro prime lens system having clear resolution with a small F number is desired.

### BRIEF SUMMARY OF THE INVENTION

Accordingly, the present invention provides a micro prime lens system having clear resolution with a small F number.

A micro prime lens system is provided, wherein from an object side to an image side, sequentially, the micro prime lens system comprises a first lens, a second lens, a third lens and a fourth lens, which have a positive, a negative, a positive and a negative index of refraction, respectively. The third lens is an aspherical lens and is made of glass material and conforms to the following condition: 0.3<f₃/f<1.5, wherein f₃ represents a focal length of the third lens, and f represents a focal length of the micro prime lens system.

The invention utilizes the aspherical surfaces of the third lens, made of glass material, to effectively improve the aberration of the micro prime lens system and successfully decrease the F number which increases aperture diameter. Therefore, the luminous flux density is enhanced and the resolution is raised.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a first embodiment of a micro prime lens system of the invention;

FIGS. 2A, 2B and 2C are graphs showing ray fan plots, field curvature and distortion of the first embodiment; and

FIG. 3 is schematic views of a second embodiment of a micro prime lens system of the invention.

### DETAILED DESCRIPTION OF THE INVENTION

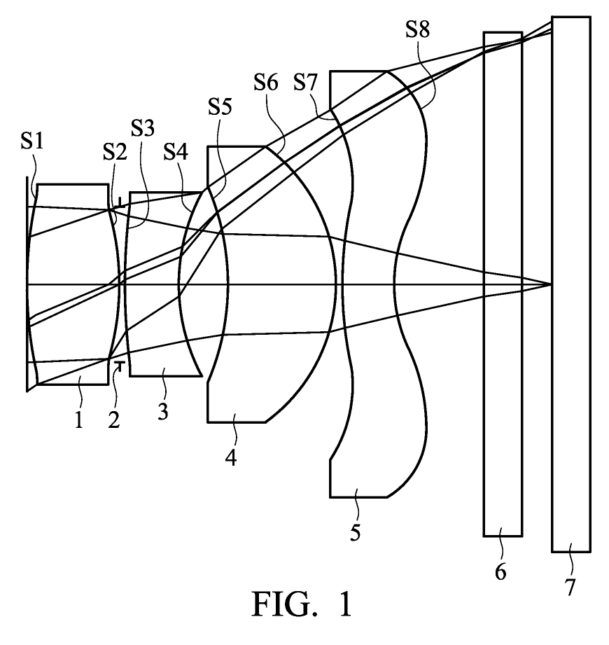

Referring to FIG. 1, a preferred embodiment of the micro prime lens system of the invention, from an object side to an image side, sequentially comprises a first lens 1, an diaphragm 2, a second lens 3, a third lens 4 and a fourth lens 5. A light beam passing the micro prime lens system enters a cover glass 6 and then forms an image in an image sensor 7 (a CCD sensor or a CMOS sensor). The first, second, third and fourth lenses 1, 3, 4, 5 have a positive, a negative, a positive and a negative index of refraction, respectively.

The first lens 1 is a biconvex lens. The diaphragm 2 is a middle aperture between the first lens 1 and the second lens 3 to increase the viewing angle. The second lens 3 is a negative meniscus lens and the third lens 4 is a positive meniscus lens. The fourth lens 5 is used for negative refraction of the chief ray and positive refraction of the marginal ray. Its main purpose is to balance the positive and negative refractions and to decrease the F number.

The micro prime lens system conforms to the following condition:

0.3<f₃/f<1.5 (1),

wherein f₃ represents a focal length of the third lens, and f represents a focal length the micro prime lens system. Note that if the value of f₃/f exceeds the upper limit of formula (1), then the positive refraction of the third lens 4 is too small, which may increase the optical path length of the micro prime lens system. Also, if the value of f₃/f is below the lower limit of the formula (1), then the radius of the third lens 4 is too small, which may cause conspicuous aberration. Moreover, the third lens 4 is made of glass, and the object side surface and the image side surface thereof are both aspherical. By choosing the appropriate material for the third lens 4, the overall size of the micro prime lens system can be shortened and the L number can be decreased to raise resolution thereof. Glass is a complex material made from variety of selections, therefore, the third lens 4 is made of glass, while the first, second and fourth lenses 1, 3, 5 are aspherical plastic lenses made of optical plastic material.

The third lens 4 conforms to the following condition:

0.3<|R₅/f₃|<1.5 (2),

wherein, R₅ represents a curvature radius of the object side surface S5 of the third lens 4. Note that if the value of f₃/f exceeds the upper limit of the formula (2), then the focal length of the third lens 4 is too small to cause conspicuous aberration. Also, if the value of f₃/f is below the lower limit of the formula (2), the of curvature radius of the object side surface S5 of the third lens 4 is too small which may also cause conspicuous aberration.

The aspherical surface is identified as follows:

$$z = \frac{{ch}^{2}}{, 1 + {[ 1 - ( k + 1 ) {c}^{2} {h}^{2} ]}^{\frac{1}{2}}} + {Ah}^{4} + {Bh}^{6} + {Ch}^{8} + {Dh}^{10} + {Eh}^{12} + {Fh}^{14} + {Gh}^{16} \qquad ( 3 )$$

The apex of the surface is used as reference, z represents the shift from the optical axis at height h along the direction of the optical axis, k represents conic coefficient, c is the inverse of the curvature radius, and A to J represent aspheric coefficients. The aspherical lens increases image formation quality. Alternatively, if a spherical lens is used instead of an aspherical lens, more space will be required for the more complex arrangement of lenses to correct aberration, thereby increasing overall size.

The micro prime lens system conforms to the formula (1) and formula (2), and the third lens 4 is made of glass material to allow the F number of the micro prime lens system to be 2, to increase the diameter of the aperture and the image resolution.

### FIRST EMBODIMENT

Table 1-1 shows various parameters of the micro prime lens system, and S1 to S8, from an object side to an image side, respectively, are the object side surface S1 of the first lens 1, the image side surface S2 of the first lens 1, and so forth . . . , to the image side surface S8 of the fourth lens 5. In the embodiment, conforming to formula (1) and formula (2), the F number is 2, the focal length f is 1.978 mm, the focal length f₃ of the third lens 4 is 1.7268 mm, R₅ is −0.7388 mm. Additionally, the Abbe coefficient of the third lens 4 is 58, which corrects aberration.

TABLE 1-1

| | | | | Abbe |
|---|---|---|---|---|
| | Curvature radius | Thickness | Refraction | Coefficients |
| Ser. No. | (mm) | (mm) | N_{d} | ν_{d} |
| S1 | 0.8411 | 0.2586 | 1.5346 | 56.0721 |
| S2 | −0.8493 | 0 | | |
| Diaphragm | | 0.0151 | | |
| S3 | 1.299 | 0.1517 | 1.6322 | 23.4299 |
| S4 | 0.5136 | 0.1336 | | |
| S5 | −0.7388 | 0.3068 | 1.61 | 58 |
| S6 | −0.3589 | 0.0151 | | |
| S7 | 0.5452 | 0.1431 | 1.5146 | 56.96 |
| S8 | 0.2767 | 0.2527 | | |

The aspheric coefficient of the first, second, third and fourth lenses 1, 3, 4, 5 are shown in Table 1-2 as follows:

TABLE 1-2

| Serial | | | | | | | | |
|---|---|---|---|---|---|---|---|---|
| No. | k | A | B | C | D | E | F | G |
| S1 | −7.9184 | −0.25939 | 19.89604 | −1767.43 | 39693.95 | −518602 | 3570561 | −1.1E+07 |
| S2 | 0 | −4.81042 | 137.5272 | −3565.71 | 43105.98 | −204890 | 0 | 0 |
| S3 | 0 | −4.34047 | 102.6754 | −1826.18 | 12858.06 | 0 | 0 | 0 |
| S4 | −1.544 | 0.192403 | 0.168106 | 34.30046 | 0 | 0 | 0 | 0 |
| S5 | −27.16 | −5.25963 | 22.42457 | −4.08092 | 0 | 0 | 0 | 0 |
| S6 | −1.311 | 2.986475 | −124.670 | 2300.514 | −23641.8 | 126536.8 | −300951 | 186922.4 |
| S7 | −5.1611 | −0.49823 | 0.665753 | −0.22656 | −0.41879 | −0.07290 | 0.345703 | 0.314148 |
| S8 | −3.6606 | −0.38786 | 0.842027 | −1.64776 | 2.294654 | −2.08297 | 1.014365 | −0.18252 |

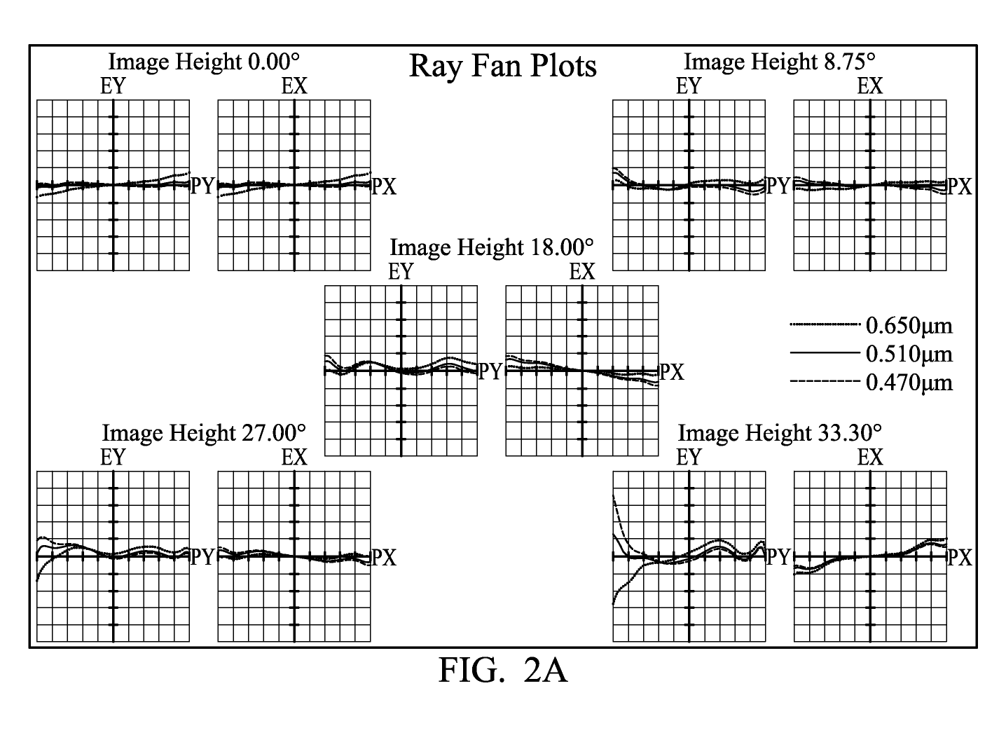

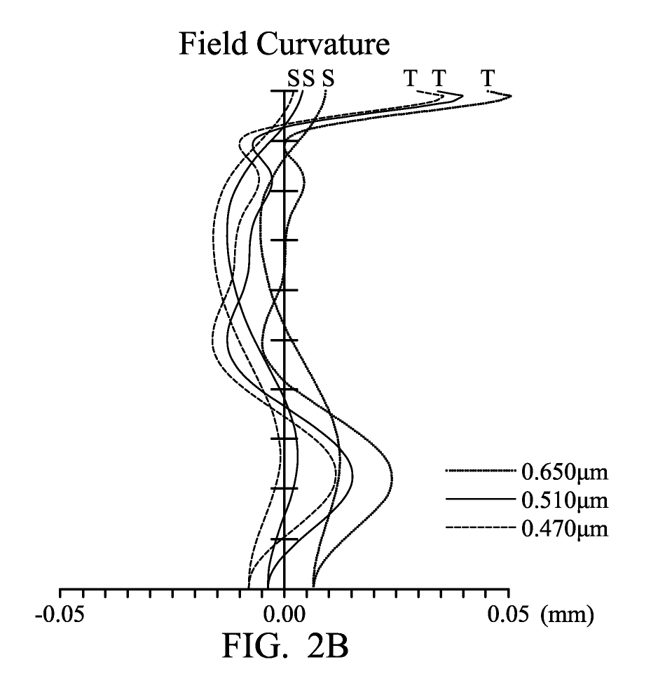

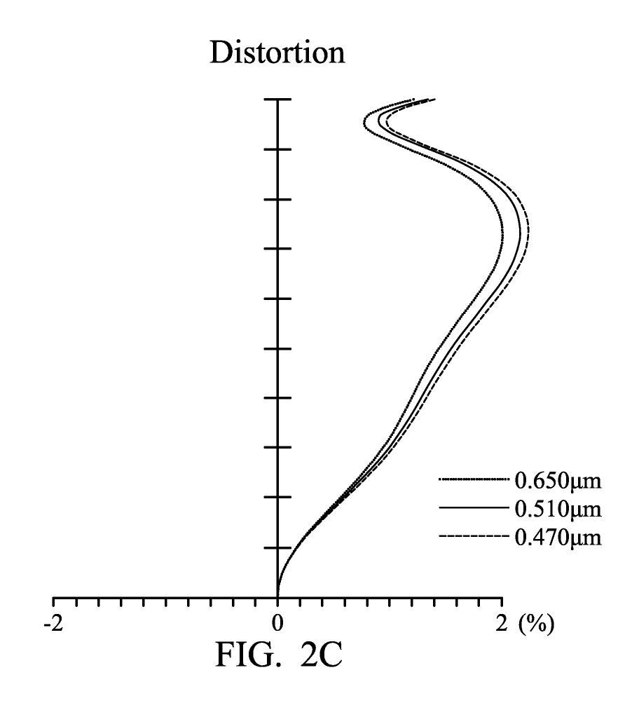

FIG. 2A shows ray fan plots with different wavelengths of different image heights. Each image height has two ray fan plots, respectively corresponding to the coma aberration on tangential plane PY and EY and sagittal plane PX and EX. According to FIG. 2A, a majority of the image formation magnification error is acceptable.

FIG. 2B is a graph showing field curvature, and image position with varying surface height. T represents the tangential light beam and S represents the sagittal light beam. The horizontal axis shows the distance between the image point and the ideal surface, and the vertical axis shows the ideal height. FIG. 2C is a distortion graph showing transverse enlargement. The horizontal axis shows percentage differences between the image point and the ideal image point, and the vertical axis shows the ideal image height. According to FIGS. 2B and 2C, the field curvature and the distortion are not serious.

### SECOND EMBODIMENT

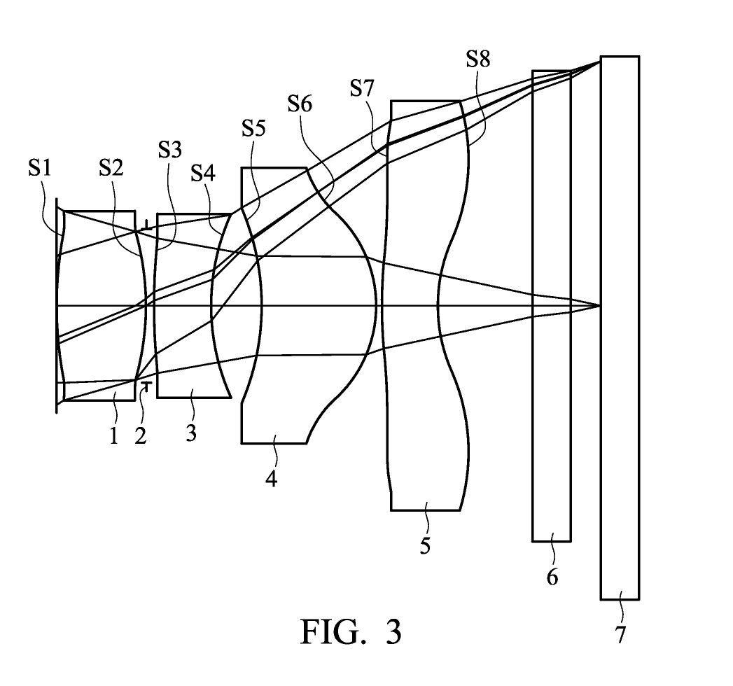

Referring to FIG. 3, Table 2-1 shows various parameters of the micro prime lens system. In the embodiment, conforming to formula (1) and formula (2), the F number is 2.0, the focal length f is 1.997 mm, the focal length f₃ of the third lens 4 if 1.21 mm, and R₅ is −0.5714 mm.

TABLE 2-1

| | | | | Abbe |
|---|---|---|---|---|
| | Curvature radius | Thickness | Refraction | Coefficients |
| Ser. No. | (mm) | (mm) | N_{d} | ν_{d} |
| S1 | 0.9300 | 0.242 | 1.59 | 56.1 |
| S2 | −0.9628 | 0 | | |
| Diaphragm | | 0.02 | | |
| S3 | 1.2974 | 0.1501 | 1.632 | 23.4 |
| S4 | 0.5450 | 0.1386 | | |
| S5 | −0.5714 | 0.3028 | 1.54 | 56.1 |
| S6 | −0.2486 | 0.0151 | | |
| S7 | 1.004 | 0.1480 | 1.5146 | 56.96 |
| S8 | 0.2685 | 0.2503 | | |

The aspheric coefficients of the first, second, third and fourth lenses 1, 3, 4, 5 are shown in Table 2-2. The schematic view of the arrangement of the micro prime lens system and the shapes of the lens according to Table 2-1 and Table 2-2 are shown in FIG. 3.

TABLE 2-2

| Serial | | | | | | | | |
|---|---|---|---|---|---|---|---|---|
| No. | k | A | B | C | D | E | F | G |
| S1 | −12.27 | −0.58397 | 20.11552 | −1965.18 | 42169.98 | −567327 | 4379465 | −1.8E+07 |
| S2 | 0 | −9.23869 | 195.5569 | −3642.71 | 30828.86 | −91511.9 | 0 | 0 |
| S3 | 0 | −9.15774 | 201.6418 | −3257.54 | 21113.52 | 0 | 0 | 0 |
| S4 | −2.247 | −0.40268 | 27.19742 | −180.719 | 0 | 0 | 0 | 0 |
| S5 | 1.042 | 1.082569 | −100.126 | 5079.628 | −118516 | 1875162 | −1.5E+07 | 44067415 |
| S6 | −2.299 | 0.734269 | −126.289 | 2513.121 | −26390.1 | 149060.4 | −247531 | −514262 |
| S7 | −26.503 | −3.4441 | 20.4243 | −46.2105 | −35.8908 | 310.0639 | 574.8613 | −2682.31 |
| S8 | −5.205 | −5.12684 | 48.47111 | −410.402 | 2341.874 | −8250.37 | 15965.13 | −12768.3 |

As described, the ratio of the focal length of the third lens 4 and the ratio of the focal length of the micro prime lens system, conforms to formula (1), and the focal length of the third lens 4 and the curvature radius of the object side surface conform to formula (2). In addition, because the third lens 4 is a glass aspherical lens, advanced glass material can be used to lower the F number and increase the aperture diameter. Thus, the luminous flux density is enhanced and the resolution is raised to achieve the goal of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro prime lens system, from an object side to an image side, sequentially comprising:
a first lens, a second lens, a third lens and a fourth lens, which have a positive, a negative, a positive and a negative refraction power, respectively, wherein the third lens is an aspherical lens made of glass material and conforms to the following condition:
0.3<f₃/f<1.5,
wherein f₃ represents a focal length of the third lens, and f represents a focal length of the micro prime lens system.

2. The micro prime lens system as claimed in claim 1, wherein an object side surface and an image side surface of the third lens are both aspherical.

3. The micro prime lens system as claimed in claim 2, wherein the micro prime lens system conforms to the following condition:
0.3<|R5/f3|<1.5,
wherein R5 represents a curvature radius of the object side surface of the third lens.

4. The micro prime lens system as claimed in claim 3, wherein the first, second and fourth lenses are made of optical plastic material.

5. The micro prime lens system as claimed in claim 4, further comprising an aperture stop between the first lens and the second lens.

6. The micro prime lens system as claimed in claim 5, wherein an F number of the micro prime lens system is 2.
